(19) United States
(12) Patent Application Publication
(10) Pub. No.: US 2024/0118371 A1
(43) Pub. Date: Apr. 11, 2024

(54) APPARATUS, METHOD, AND COMPUTER PROGRAM PRODUCT FOR COMMUNICATION NODE LOCALIZATION

(71) Applicant: HERE GLOBAL B.V., Eindhoven (NL)

(72) Inventors: Henri Jaakko Julius NURMINEN, Tampere (FI); Marko LUOMI, Lempaala (FI); Pavel IVANOV, Tampere (FI); Lauri Aarne Johannes WIROLA, Tampere (FI)

(21) Appl. No.: 18/045,285

(22) Filed: Oct. 10, 2022

(51) Int. Cl. G01S 5/02

(52) U.S. Cl. CPC G01S 5/02524; G01S 5/02216; G01S 5/0246

(57) ABSTRACT

An apparatus, method, and computer program product are provided for communication node localization. For example, a digital fingerprint associated with a communication node in a communication environment is received. The digital fingerprint includes at least location data associated with a location estimate of the communication node and timestamp data associated with one or more measurements with respect to the communication node. Based at least in part on the timestamp data associated with the digital fingerprint, a frequency distribution data structure for the communication node is configured. Additionally, the location data is refined to generate refined location data for the communication node based on a comparison of one or more characteristics between the frequency distribution data structure and respective timetable data structures for respective scheduled events associated with an event location deemed to be at least proximate to the location data.

### TECHNOLOGICAL FIELD

An example embodiment of the present disclosure generally relates to positioning system technologies for mobile devices and, more particularly, to an apparatus, method, and computer program product for communication node localization.

### BACKGROUND

Various positioning systems have been developed for determining position of a mobile device, such as a smart phone or other types of user equipment. However, it is often difficult for a positioning system to accurately determine a position of a mobile device in an indoor environment or another type of environment where it is difficult for a receiver of the mobile device to receive signals from a satellite system or another type of reference system.

### BRIEF SUMMARY

An apparatus, method, and computer program product are provided in order to provide communication node localization. As such, precision and/or confidence of predicted locations for mobile device positioning, navigation, routing, and/or journey planning purposes can be improved.

In an example embodiment, an apparatus is configured for communication node localization. The apparatus includes processing circuitry and at least one memory including computer program code instructions that are configured to, when executed by the processing circuitry, cause the apparatus to receive a digital fingerprint associated with a communication node in a communication environment. In one or more embodiments, the digital fingerprint comprises at least location data associated with a location estimate of the communication node and timestamp data associated with one or more measurements with respect to the communication node. The computer program code instructions are also configured to, when executed by the processing circuitry, cause the apparatus to configure a frequency distribution data structure for the communication node based at least in part on the timestamp data associated with the digital fingerprint. Additionally, the computer program code instructions are configured to, when executed by the processing circuitry, cause the apparatus to refine the location data to generate refined location data for the communication node based on a comparison of one or more characteristics between the frequency distribution data structure and respective timetable data structures for respective scheduled events associated with an event location deemed to be at least proximate to the location data.

In one or more embodiments, the computer program code instructions are configured to, when executed by the processing circuitry, cause the apparatus to modify a portion of the frequency distribution data structure that corresponds to a time value associated with the timestamp data.

In one or more embodiments, the frequency distribution data structure is configured as a histogram data structure associated with a histogram representing a frequency distribution of at least the timestamp data. In one or more embodiments, the computer program code instructions are configured to, when executed by the processing circuitry, cause the apparatus to alter a data bin width associated with a defined interval of time for the histogram data structure based on the timestamp data associated with the digital fingerprint. In one or more embodiments, the computer program code instructions are configured to, when executed by the processing circuitry, cause the apparatus to alter a histogram length for the histogram data structure based on the timestamp data associated with the digital fingerprint.

In one or more embodiments, the computer program code instructions are configured to, when executed by the processing circuitry, cause the apparatus to compare frequency distribution peaks associated with the frequency distribution data structure to timetable times associated with the respective timetable data structure to refine the location data. In one or more embodiments, the computer program code instructions are configured to, when executed by the processing circuitry, cause the apparatus to compare the one or more characteristics between the frequency distribution data structure and the respective timetable data structures based on a probability model applied to data within the frequency distribution data structure and the respective timetable data structures.

In one or more embodiments, the computer program code instructions are configured to, when executed by the processing circuitry, cause the apparatus to configure at least a portion of a radio model for the communication node based on the refined location data for the communication node.

In one or more embodiments, the computer program code instructions are configured to, when executed by the processing circuitry, cause the apparatus to receive the digital fingerprint from a mobile device located within the communication environment.

In one or more embodiments, the respective timetable data structures comprise at least one public transportation timetable data structure for at least one public transportation event associated with a public transportation event location deemed to be at least proximate to the location data. In one or more embodiments, the respective timetable data structures comprise at least one event venue timetable data structure for at least one event venue associated with an event venue location deemed to be at least proximate to the location data.

In another example embodiment, a computer-implemented method is provided for communication node localization. The computer-implemented method includes receiving a digital fingerprint associated with a communication node in a communication environment. In one or more embodiments, the digital fingerprint comprises at least location data associated with a location estimate of the communication node and timestamp data associated with one or more measurements with respect to the communication node. The computer-implemented method also includes configuring a frequency distribution data structure for the communication node based at least in part on the timestamp data associated with the digital fingerprint. Additionally, the computer-implemented method includes refining the location data to generate refined location data for the communication node based on a comparison of one or more characteristics between the frequency distribution data structure and respective timetable data structures for respective scheduled events associated with an event location deemed to be at least proximate to the location data.

In one or more embodiments, configuring the frequency distribution data structure comprises modifying a portion of the frequency distribution data structure that corresponds to a time value associated with the timestamp data.

In one or more embodiments, configuring the frequency distribution data structure comprises configuring a histogram data structure associated with a histogram representing a frequency distribution of at least the timestamp data. In one or more embodiments, configuring the histogram data structure comprises altering a data bin width associated with a defined interval of time for the histogram data structure based on the timestamp data associated with the digital fingerprint. In one or more embodiments, configuring the histogram data structure comprises altering a histogram length for the histogram data structure based on the timestamp data associated with the digital fingerprint.

In one or more embodiments, refining the location data comprises comparing frequency distribution peaks associated with the frequency distribution data structure to timetable times associated with the respective timetable data structure to refine the location data.

In one or more embodiments, refining the location data comprises comparing the one or more characteristics between the frequency distribution data structure and the respective timetable data structures based on a probability model applied to data within the frequency distribution data structure and the respective timetable data structures.

In one or more embodiments, the computer-implemented method also includes configuring at least a portion of a radio model for the communication node based on the refined location data for the communication node.

In another example embodiment, a computer program product is provided. The computer program product includes at least one non-transitory computer readable storage medium having computer-executable program code instructions stored therein with the computer-executable program code instructions including program code instructions configured, upon execution, to receive a digital fingerprint associated with a communication node in a communication environment. In one or more embodiments, the digital fingerprint comprises at least location data associated with a location estimate of the communication node and timestamp data associated with one or more measurements with respect to the communication node. The computer-executable program code instructions are also configured to configure a frequency distribution data structure for the communication node based at least in part on the timestamp data associated with the digital fingerprint. Additionally, the computer-executable program code instructions are configured to refine the location data to generate refined location data for the communication node based on a comparison of one or more characteristics between the frequency distribution data structure and respective timetable data structures for respective scheduled events associated with an event location deemed to be at least proximate to the location data.

In one or more embodiments, the computer-executable program code instructions are also configured to modify a portion of the frequency distribution data structure that corresponds to a time value associated with the timestamp data.

In one or more embodiments, the frequency distribution data structure is configured as a histogram data structure associated with a histogram representing a frequency distribution of at least the timestamp data. In one or more embodiments, the computer-executable program code instructions are also configured to alter a data bin width associated with a defined interval of time for the histogram data structure based on the timestamp data associated with the digital fingerprint. In one or more embodiments, the computer-executable program code instructions are also configured to alter a histogram length for the histogram data structure based on the timestamp data associated with the digital fingerprint.

In one or more embodiments, the computer-executable program code instructions are also configured to compare frequency distribution peaks associated with the frequency distribution data structure to timetable times associated with the respective timetable data structure to refine the location data. In one or more embodiments, the computer-executable program code instructions are also configured to compare the one or more characteristics between the frequency distribution data structure and the respective timetable data structures based on a probability model applied to data within the frequency distribution data structure and the respective timetable data structures.

In one or more embodiments, the computer-executable program code instructions are also configured to configure at least a portion of a radio model for the communication node based on the refined location data for the communication node.

In one or more embodiments, the computer-executable program code instructions are also configured to receive the digital fingerprint from a mobile device located within the communication environment.

In one or more embodiments, the respective timetable data structures comprise at least one public transportation timetable data structure for at least one public transportation event associated with a public transportation event location deemed to be at least proximate to the location data. In one or more embodiments, the respective timetable data structures comprise at least one event venue timetable data structure for at least one event venue associated with an event venue location deemed to be at least proximate to the location data.

In yet another example embodiment, an apparatus is provided that includes means for receiving a digital fingerprint associated with a communication node in a communication environment. In one or more embodiments, the digital fingerprint comprises at least location data associated with a location estimate of the communication node and timestamp data associated with one or more measurements with respect to the communication node. The apparatus of this example embodiment also comprises means for configuring a frequency distribution data structure for the communication node based at least in part on the timestamp data associated with the digital fingerprint. The apparatus of this example embodiment also comprises means for refining the location data to generate refined location data for the communication node based on a comparison of one or more characteristics between the frequency distribution data structure and respective timetable data structures for respective scheduled events associated with an event location deemed to be at least proximate to the location data.

In one or more embodiments, means for configuring the frequency distribution data structure comprises means modifying a portion of the frequency distribution data structure that corresponds to a time value associated with the timestamp data.

In one or more embodiments, means for configuring the frequency distribution data structure comprises means for configuring a histogram data structure associated with a histogram representing a frequency distribution of at least the timestamp data. In one or more embodiments, means for configuring the histogram data structure comprises means for altering a data bin width associated with a defined interval of time for the histogram data structure based on the timestamp data associated with the digital fingerprint. In one or more embodiments, means for configuring the histogram data structure comprises means for altering a histogram length for the histogram data structure based on the timestamp data associated with the digital fingerprint.

In one or more embodiments, means for refining the location data comprises means for comparing frequency distribution peaks associated with the frequency distribution data structure to timetable times associated with the respective timetable data structure to refine the location data.

In one or more embodiments, means for refining the location data comprises means for comparing the one or more characteristics between the frequency distribution data structure and the respective timetable data structures based on a probability model applied to data within the frequency distribution data structure and the respective timetable data structures.

In one or more embodiments, the apparatus of this example embodiment also comprises means for configuring at least a portion of a radio model for the communication node based on the refined location data for the communication node.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus configured for communication node localization in accordance with one or more example embodiments of the present disclosure;

FIG. 2 is a flowchart illustrating operations performed, such as by the apparatus of FIG. 1, in order to provide communication node localization in accordance with one or more example embodiments of the present disclosure;

FIG. 3 illustrates a system to facilitate communication node and/or mobile device localization in accordance with one or more example embodiments of the present disclosure;

FIG. 4 illustrates an example frequency distribution data structure in accordance with one or more example embodiments of the present disclosure;

FIG. 5 illustrates a data flow diagram of a system related to the apparatus of FIG. 1 in accordance with one or more example embodiments of the present disclosure; and

FIG. 6 is an example embodiment of an architecture specifically configured for implementing embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

Various positioning systems have been developed for determining the position of a mobile device, such as a smart phone or other types of user equipment. At least some of these positioning systems utilize radio models of wireless access points that, in turn, are based on probe points that have been collected by a plurality of mobile devices. The wireless access points may be part of a cellular system or a non-cellular system. For example, a cellular system may include, but is not limited to, a Global System for Mobile communications (GSM) system, a wideband code division multiple access (WCDMA) system, a time division synchronous code division system multiple access (TD-SCDMA) system, a Long Term Evolution (LTE) system, a Long Term Evolution Advanced (LTE-A) system, a code division multiple access (CDMA) system, a NarrowBand-Internet of Things (NB-IoT) system, a fourth-generation (4G) system, a fifth-generation (5G) system, sixth-generation (6G) system, or another type of cellular system. A non-cellular system may include, but is not limited to, a Wireless Local Area Network (WLAN) system, a Bluetooth (BT) system, a Bluetooth Low Energy (BTLE) system, a Zigbee system, a long range (LoRa) system, or another type of non-cellular system.

In relation to the radio models of wireless access points that are utilized by positioning systems, databases containing information regarding the radio signals received by mobile devices at different locations relative to the access points are created. Accordingly, a large portion of the information in the databases generally originates from the mobile devices. Collection of information from mobile devices in this way is generally referred to as crowdsourcing.

In this regard, the databases are typically formed of data provided by the mobile devices in the form of probe points that serve as radio fingerprints. Each probe point includes an estimate of the location of the mobile device at the time at which the radio signals were captured and a measurement of the radio signals that were captured. With respect to cellular signals, the measurement of the cellular signals may include an identification of the access point, that is, the cellular network cell, e.g., base station, that is transmitting the cellular signals that are received by the mobile device, such as a global and/or local identifier (ID) of the cellular network cell. The measurement of the cellular signals may also include a measurement of the signal strength and/or an estimate of the path loss as well as a timing measurement, such as a Timing Advance measurement or a Round-Trip Time measurement. With respect to the measurement of a non-cellular signal, the measurement may include an identification of the access point generating the non-cellular signals that are received by the mobile device, such as the basic service set identifiers (BSSIDs), e.g., a media access control (MAC) address of the air interface of an access point, e.g., a WLAN access point, or the service set identifier (SSID) or network name of the access point, e.g., WLAN access point. The measurement of a non-cellular signal also includes a measure of the signal strength, such as the received signal strength, the receiver level, etc. and/or a path loss estimate. In some embodiments, the measurement of a non-cellular signal also includes a timing measurement, such as the Round-Trip Time measurement.

The data, such as the probe points, collected by the plurality of mobile devices is generally uploaded, such as to a server or the cloud. By reference to the data, the positioning system then generates or updates radio models of the wireless access points that define the signal characteristics of radio signals that are transmitted by the wireless access points and received by mobile devices at different respective locations. The radio model may then be utilized for positioning purposes, that is, to determine the location of a mobile device based upon radio signals received by the mobile device at the respective location. Various radio models may be constructed including radio models based upon the coverage areas of the access points, radio models based upon the positions of the access points, radio propagation models, radio models based upon the receiver fields of the access points or the like. The resulting radio models may be stored by one or more network entities, such as by the positioning system, and/or may be transferred to one or more of the mobile devices.

The radio models may then be utilized to determine the position of a mobile device. For example, while a mobile device is at an unknown location, the mobile device may capture measurements of the cellular or non-cellular signals transmitted by the access points. By reference to the radio models that have been constructed, the measurements of the radio signals may be evaluated, and the location of the mobile terminal may be determined, such as based upon the coverage areas of the access points.

However, a major challenge for crowdsourcing data from mobile devices is determining adequate location references for fingerprints. For outdoor environments, a Global Navigation Satellite System (GNSS) is generally available as a location reference for fingerprints. However, for certain environments such as indoor environments or other environments with low-quality GNSS capabilities (e.g., in tunnels, public transport stations, urban canyons, etc.), fingerprints are often collected without a location reference. Thus, in such environments, a positioning service and/or location service for a mobile device may be unavailable.

To address these and/or other issues, an apparatus, method, and computer program product are provided in accordance with an example embodiment in order to provide communication node localization. The communication node localization can provide improved location-based services for certain environments such as indoor environments or other environments with low-quality GNSS capabilities (e.g., in tunnels, public transport stations, urban canyons, etc.). The communication node localization can also provide improved location predictions for radio models and/or radio maps employed for location-based services.

In various embodiments, a location of a communication node can be learned for a communication environment where mobile devices are employed by users for scheduled activities and/or events with available timetables. For example, particular times at which incoming crowd-sourcing data is provided to a radio model for a communication node can be learned and/or leveraged to provide improved location predictions for communication nodes and/or mobile devices. In particular, if a particular time value related to incoming crowd-sourcing data coincides with a particular time for a scheduled activity or event, it can be determined that the communication node is likely located at least proximate to a location where the scheduled activity or event is provided. The learned time values may be absolute timestamps, a time of day, a time of week, a time of month, and/or another type of time value. According to one or more embodiments, a predicted location for a communication node and/or mobile device can be uploaded to a mapping server. Furthermore, in certain embodiments, the predicted location can be aggregated into information to facilitate mapping, routing and/or navigation for location services.

Accordingly, the communication node localization can be employed to provide improved mapping, routing and/or navigation for location services. In certain embodiments, the communication node localization can be employed to improve accuracy of a radio model and/or a radio map related to location services. Additionally or alternatively, in certain embodiments, the communication node localization can be employed to provide improved user interfaces associated with mapping, routing and/or navigation. For example, in one or more embodiments, improved location predictions for communication nodes and/or mobile devices can reduce a number of queries and/or a number of displays associated with a user interface employed for mapping, routing and/or navigation. Computational resources for a mobile device associated with the user interface (e.g., the user interface related to mapping, routing and/or navigation) can also be conserved and/or reduced.

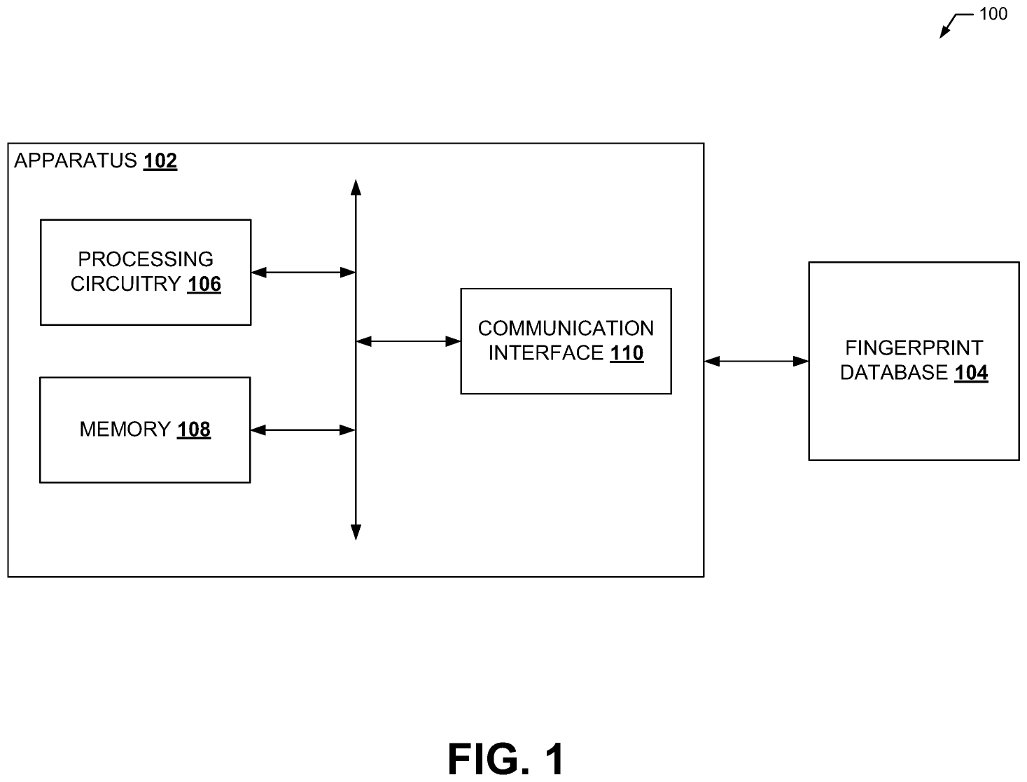

With reference to FIG. 1, a system 100 configured for communication node localization is depicted, in accordance with one or more embodiments of the present disclosure. In the illustrated embodiment, the system 100 includes an apparatus 102 and a fingerprint database 104. As described further below, the apparatus 102 is configured in accordance with an example embodiment of the present disclosure to assist positioning, localization, crowdsourcing, mapping, routing, navigation, and/or other applications related to mobile devices. The apparatus 102 can be embodied by any of a wide variety of systems and/or computing devices including, for example, a server system, a cloud-based computing system, a positioning system, a location service system (e.g., a location data and technology platform system, a cloud-based location platform service system, etc.), an urban mobility system, a navigation system, a routing system, a mapping system, a mobile device system, a consumer device system, a vehicle system, a transportation system, a control system, an electronic control unit, an autonomous vehicle control system, an Advanced Driver Assistance System module (ADAS of a vehicle), or another type of system. In certain embodiments, the apparatus 102 may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device and/or system that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 102 to carry out various functions in accordance with an example embodiment of the present disclosure. For example, the memory 108 can be configured to buffer input data for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the fingerprint database 104 that stores fingerprint data. The fingerprint data can include one or more fingerprints (e.g., one or more digital fingerprints) that respectively contain a location reference, a timestamp, and/or one or more measurements obtained from a radio interface. For example, the one or more measurements can include a global identifier of a cellular network cell, a local identifier of a cellular network cell, a signal strength measurement (e.g., a signal strength index, a receiver level, etc.), a pathloss estimate, a timing measurement (e.g., timing advance or round-trip time), a BSSID of a wireless access point, a MAC of an air interface of a wireless access point, an SSID, a measurement related to an environment associated with a mobile device (e.g., a magnetic field measurement), and/or another type of measurement. The fingerprint data can additionally or alternatively include user profile data, metadata, and/or other data generated and/or employed by the processing circuitry 106.

Additionally or alternatively, the communication interface 110 can be configured to communicate in accordance with various wireless protocols including, but not limited to, GSM, LTE, 4G, 5G, 6G, etc. In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

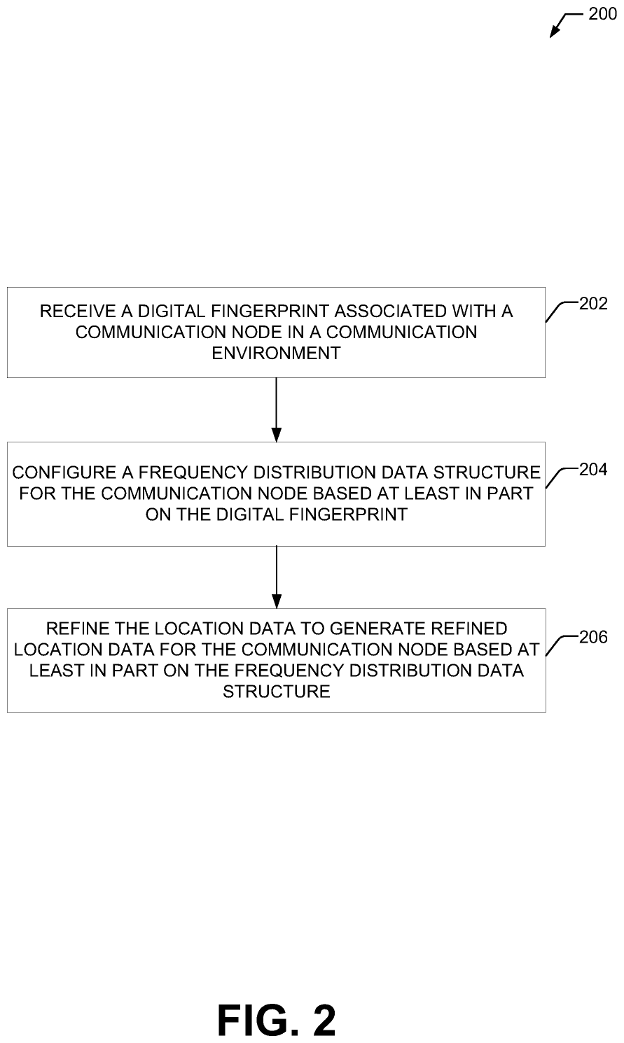

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 2, the operations performed, such as by the apparatus 102 of FIG. 1, in order to provide communication node localization, in accordance with one or more embodiments of the present disclosure. As shown in block 202 of FIG. 2, the apparatus 102 includes means, such as the processing circuitry 106, the memory 108, or the like, configured to receive a digital fingerprint associated with a communication node in a communication environment. In one or more embodiments, the digital fingerprint comprises at least location data associated with a location estimate of the communication node and timestamp data associated with one or more measurements with respect to the communication node. The digital fingerprint can be a radio fingerprint configured for updating a radio map of the communication environment associated with the communication node. For example, the digital fingerprint can digitally represent the location estimate and respective radio signal measurements with respect to the communication node. The communication node can be a radio device such as, for example, an access point of a wireless network. In various embodiments, the digital fingerprint can be generated by a mobile device communicatively coupled to the communication node. Additionally, in various embodiments, the mobile device or the communication node can provide the digital fingerprint. In one or more embodiments, the apparatus 102, such as the processing circuitry 106, can be configured to receive the digital fingerprint from a mobile device located within the communication environment.

The digital fingerprint can be related to a particular measurement with respect to the communication node. In various embodiments, the particular measurement related to the digital fingerprint can be a measurement from a plurality of measurements with respect to the communication node. For example, at least a first measurement with respect to the communication node can include the location data and at least a second measurement with respect to the communication node can be captured without location data for the communication node. Additionally, the digital fingerprint related to the first measurement can be generated in response to identification of the location data via the first measurement.

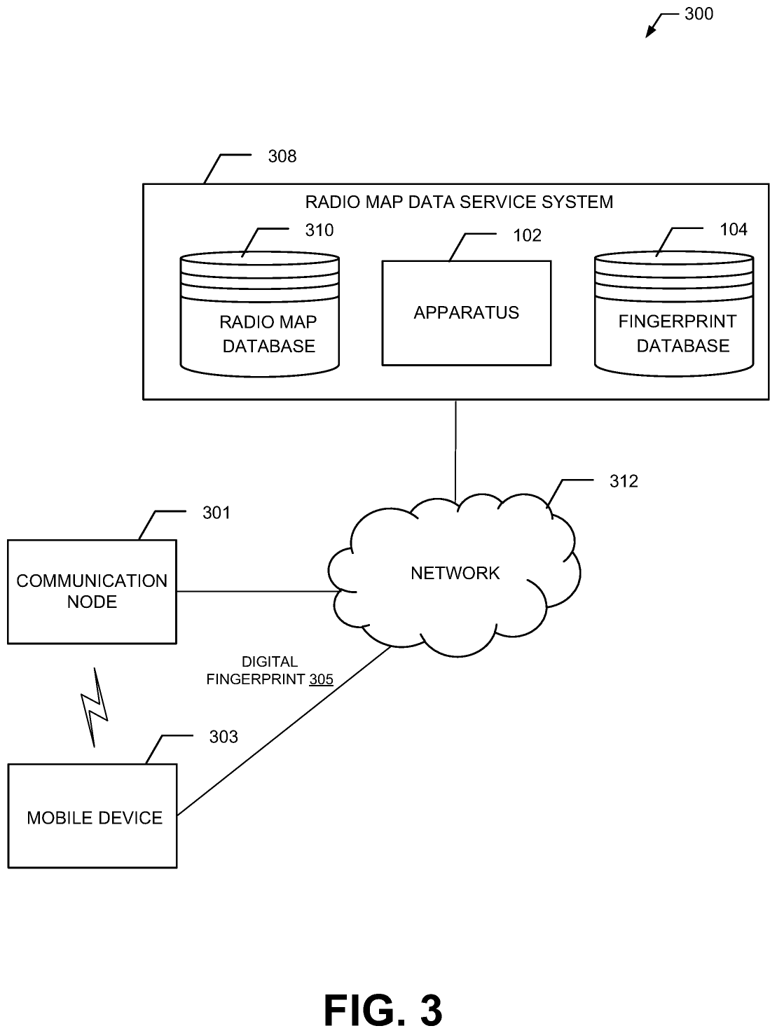

FIG. 3 illustrates a system 300 related to a communication node in a communication environment, in accordance with one or more example embodiments of the present disclosure. The system 300 includes a communication node 301, a mobile device 303, and a radio map data service system 308. The communication node 301 and the radio map data service system 308 can be communicatively coupled via a network 312. The mobile device 303 can be communicatively coupled to the communication node 301 via one or more wireless communication channels. In certain embodiments, the mobile device 303 can also be communicatively coupled to the radio map data service system 308 via a network 312.

The communication node 301 and the mobile device 303 can be located in a corresponding communication environment. For example, the communication node 301 and the mobile device 303 can be located in an outdoor environment or an indoor environment with undesirable GNSS capabilities (e.g., a tunnel, a public transport station, an urban canyon, a room inside a building, etc.). The communication node 301 can be an access point (e.g., a wireless access point) associated with a cellular system or a non-cellular system. For example, the communication node 301 can be a communication node of a cellular system such as, but is not limited to, a GSM system, a WCDMA system, a TD-SCDMA system, an LTE system, an LTE-A system, a CDMA system, an NB-IoT system, or another type of cellular system. In another example, the communication node 301 can be a communication node of a non-cellular system such as, but is not limited to, a WLAN system, a BT system, a BTLE system, a Zigbee system, an LoRa system, or another type of non-cellular system.

The mobile device 303 can be a mobile phone, a smartphone, a smart device, a wearable device, a navigation system, or another type of mobile device. In one or more embodiments, the mobile device 303 can generate a digital fingerprint 305. Information included in the digital fingerprint 305 can be associated with the communication node 301 and/or the mobile device 303. For example, the digital fingerprint 305 can include location data associated with a location estimate of the communication node 301, one or more measurements with respect to the communication node 301, and/or timestamp data associated with one or more measurements with respect to the communication node 301.

The one or more measurements can be captured by the mobile device 303 and/or the communication node 301. Additionally, the one or more measurements can include a global identifier of a cellular network cell of the communication node 301, a local identifier of a cellular network cell of the communication node 301, a signal strength measurement (e.g., a signal strength index, a receiver level, etc.) between the mobile device 303 and the communication node 301, a pathloss estimate between the mobile device 303 and the communication node 301, a timing measurement (e.g., timing advance or round-trip time) between the mobile device 303 and the communication node 301, a BSSID of the communication node 301, a MAC of an air interface of the communication node 301, an SSID related to the communication node 301, a measurement related to a communication environment associated with the communication node 301 and/or the mobile device 303 (e.g., a magnetic field measurement associated with the communication node 301 and/or the mobile device 303), another type of measurement associated with the communication node 301, and/or another type of measurement associated with the mobile device 303.

The fingerprint data can additionally or alternatively include user profile data for a user associated with the mobile device 303, metadata associated with the mobile device 303, and/or other data associated with the mobile device 303. In certain embodiments, the mobile device 303 can be implemented with one or more other mobile devices to collect digital fingerprints during a training stage related to the radio map data service system 308.

The radio map data service system 308 can be associated with a radio map data service provider. In one or more embodiments, the radio map data service system 308 includes the apparatus 102, the fingerprint database 104, and/or a radio map database 310. In one or more embodiments, the apparatus 102 receives the digital fingerprint 305 from the mobile device 303. The radio map database 310 can store one or more radio maps and/or data related to one or more data maps for at least the communication environment associated with the communication node 301 and/or the mobile device 303. A radio map stored in the radio map database 310 can be configured to enable a mobile device to estimate a position of the mobile device based on one or more measurements captured by a radio interface of the mobile device. In various embodiments, a radio map can be configured as a geometric radio model.

As shown in block 204 of FIG. 2, the apparatus 102 additionally includes means, such as the processing circuitry 106, the memory 108, or the like, configured to configure a frequency distribution data structure for the communication node based at least in part on the digital fingerprint. In one or more embodiments, the apparatus 102, such as the processing circuitry 106 can be configured to configure the frequency distribution data structure for the communication node based at least in part on timestamp data associated with the digital fingerprint. For example, the apparatus 102, such as the processing circuitry 106, can be configured to modify a portion of the frequency distribution data structure that corresponds to a time value associated with the timestamp data.

In one or more embodiments, the frequency distribution data structure can be configured as a histogram data structure associated with a histogram representing a frequency distribution of at least the timestamp data. Additionally, in one or more embodiments, the apparatus 102, such as the processing circuitry 106, can be configured to alter a data bin width associated with a defined interval of time for the histogram data structure based on the timestamp data associated with the digital fingerprint. The apparatus 102, such as the processing circuitry 106, can additionally or alternatively be configured to alter a histogram length for the histogram data structure based on the timestamp data associated with the digital fingerprint.

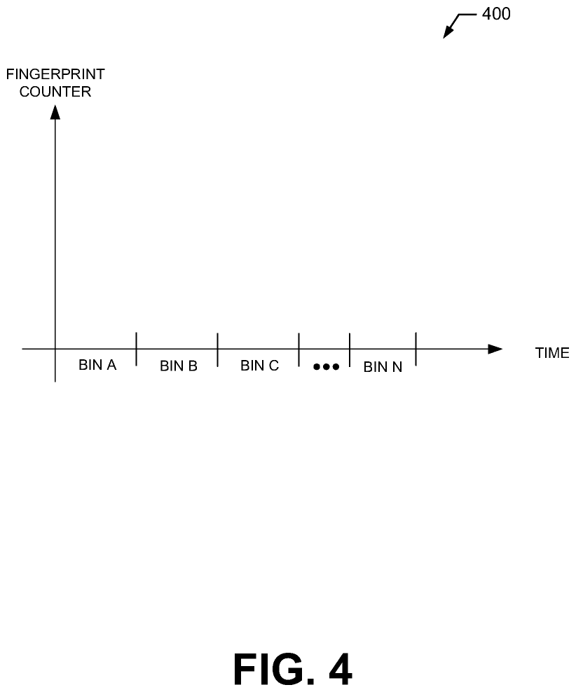

Referring to FIG. 4, illustrated is an example frequency distribution data structure 400 in accordance with one or more example embodiments of the present disclosure. In various embodiments, the frequency distribution data structure 400 can be configured as a histogram data structure that maintains a histogram of fingerprint measurement timestamps for a communication node such as, for example, the communication node 301. For example, an x-axis of the frequency distribution data structure 400 associated with time can be divided into bins A-N and a y-axis of the frequency distribution data structure 400 can maintain a fingerprint counter for respective bins A-N. Accordingly, when a digital fingerprint for a communication node associated with the frequency distribution data structure 400 is received, the apparatus 102, such as the processing circuitry 106, can be configured to increment a respective fingerprint counter for a bin corresponding to a timestamp for the digital fingerprint.

The frequency distribution data structure 400 can be configured as a periodical histogram or a non-periodical histogram. For example, a bin of the frequency distribution data structure 400 configured as a periodical histogram can include counts of a time of day, week, or month (e.g., counts of 8.00-8.15 over a certain interval of days). In another example, a bin of the frequency distribution data structure 400 configured as a non-periodical histogram can include counts of an individual time slot (e.g., counts of 8.00-8.15 on a particular day). A periodical histogram configuration for the frequency distribution data structure 400 can provide improved results for implementations where public transport timetables are employed by the apparatus 102 (e.g., a histogram for at least one weekday, a histogram for Saturday, and/or a histogram for Sunday).

A bin width for the bins A-N can correspond to a certain interval of time (e.g., n seconds, n minutes, n hours, n days, etc.). For example, a bin width for the bins A-N can correspond to 1 minute for a metro station timetable implementation related to the apparatus 102, a bin width for the bins A-N can correspond to 5 minutes for a long-distance train station timetable implementation related to the apparatus 102, a bin width for the bins A-N can correspond to 15 minutes for a cinema or theater timetables implementation related to the apparatus 102, etc. In certain embodiments, the apparatus 102, such as the processing circuitry 106, can be configured to adaptively modify a bin width for the bins A-N. For instance, the apparatus 102, such as the processing circuitry 106, can be configured to reduce or increase a bin width for the bins A-N based on fingerprint counter threshold criteria, time of day criteria, historical data for a particular location, etc.

In an example, the apparatus 102, such as the processing circuitry 106, can be configured to double a bin width for the bins A-N in response to a determination that a median fingerprint counter value is below a certain fingerprint counter threshold (e.g., a fingerprint counter threshold value of 5). In another example, the apparatus 102, such as the processing circuitry 106, can be configured to halve a bin width for the bins A-N in response to a determination that a median fingerprint counter value is above a certain fingerprint counter threshold (e.g., a fingerprint counter threshold value of 50). In certain embodiments, the apparatus 102, such as the processing circuitry 106, can be configured to adaptively modify a bin width for the bins A-N as a function of time. For example, the apparatus 102, such as the processing circuitry 106, can be configured to reduce a bin width for the bins A-N based on a determined busiest time of day (e.g., a certain time during a weekday). In another example, the apparatus 102, such as the processing circuitry 106, can be configured to increase a bin width for the bins A-N based on a determined non-busy time of day (e.g., a certain time during an evening or weekend).

In certain embodiments, the apparatus 102, such as the processing circuitry 106, can be configured to remove one or more bins from the bins A-N of the frequency distribution data structure 400 based on histogram peak times for the frequency distribution data structure 400. For example, the apparatus 102, such as the processing circuitry 106, can be configured to remove one or more bins determined to be older than a certain histogram peak. The histogram peak can be a largest histogram peak of the frequency distribution data structure 400 or a certain histogram peak ranked with respect to the largest histogram peak of the frequency distribution data structure 400.

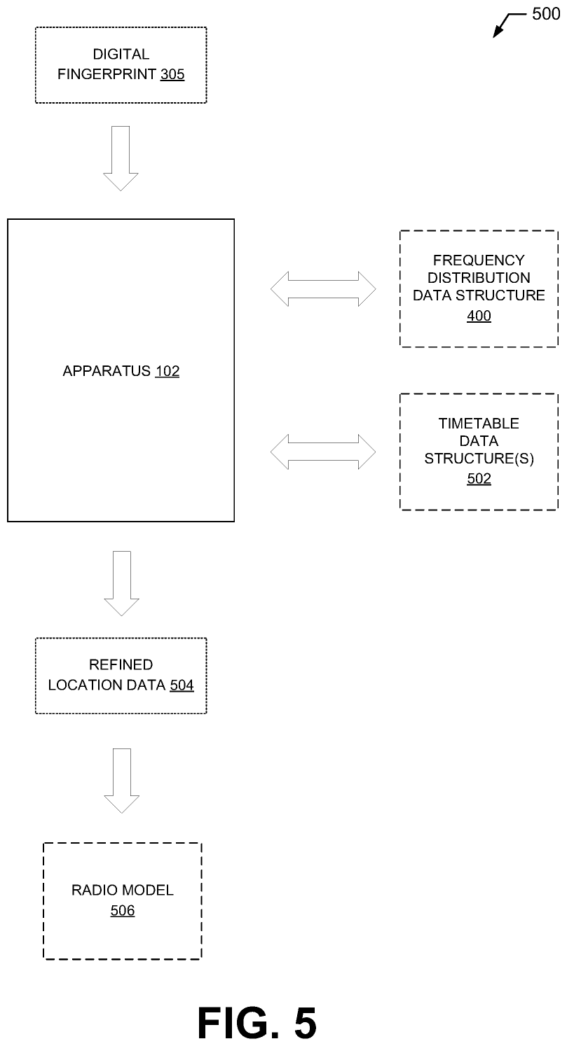

Referring now to FIG. 5, a data flow diagram of a system 500 related to the apparatus 102 is illustrated, in accordance with one or more example embodiments of the present disclosure. The system 500 includes the apparatus 102 that receives the digital fingerprint 305. Based on timestamp data included in the digital fingerprint 305, the apparatus 102, such as the processing circuitry 106, can be configured to update the frequency distribution data structure 400. For example, based on timestamp data included in the digital fingerprint 305, the apparatus 102, such as the processing circuitry 106, can be configured to increment a respective fingerprint counter for a respective bin related to the timestamp data.

As shown in block 206 of FIG. 2, the apparatus 102 additionally includes means, such as the processing circuitry 106, the memory 108, or the like, configured to refine the location data to generate refined location data for the communication node based at least in part on the frequency distribution data structure. In one or more embodiments, the apparatus 102, such as the processing circuitry 106, can be configured to refine the location data to generate the refined location data for the communication node based on a comparison of one or more characteristics between the frequency distribution data structure and respective timetable data structures for respective scheduled events associated with an event location deemed to be at least proximate to the location data. Additionally or alternatively, the apparatus 102, such as the processing circuitry 106, can be configured to determine location data for a mobile device associated with the communication node based on a comparison of one or more characteristics between the frequency distribution data structure and respective timetable data structures for respective scheduled events associated with an event location deemed to be at least proximate to the location data.

The one or more characteristics can include characteristics of one or more bins of the frequency distribution data structure such as, for example, a value of bin, histogram peaks, a height of a histogram peak, frequency of occurrence within a respective bin interval, a speak of histogram peaks, a sample size for the frequency distribution data structure, a fitted distribution of data of the frequency distribution data structure, a grouping of data of the frequency distribution data structure, a shape of a histogram related to the frequency distribution data structure, a frequency density of data for the frequency distribution data structure, and/or another characteristic related to the frequency distribution data structure.

The event location can be a location of a respective scheduled event within a certain distance from the location data. For instance, an event location can be deemed to be at least proximate to the location data based on the event location being within a certain distance from the location data. In a non-limiting example, an event location can be deemed to be at least proximate to the location data based on the event location being within 2 kilometers or another distance from the location data. As such, if the location data coincides with a particular event location for a scheduled event and/or one or more characteristics between the frequency distribution data structure and a timetable data structure for the scheduled event are determined to match, it can be determined that the communication node is likely located at least proximate to the event location where the scheduled event is provided.

The respective timetable data structures can include at least one public transportation timetable data structure for at least one public transportation event associated with a public transportation event location deemed to be at least proximate to the location data. For example, the public transportation timetable data structure can be related to a timetable for a train, a timetable for a bus, a timetable for a subway train, a timetable for a railcar, a timetable for a rapid transit vehicle, a timetable for a tram, a timetable for a ride service vehicle, a timetable for a shared vehicle, a timetable for a taxi, a timetable for an on-demand vehicle, a timetable for a plane, and/or a timetable for another public transportation entity. Accordingly, the at least public transportation event can be related to one or more events at a public transport station associated with a train, a bus, a subway train, a railcar, a rapid transit vehicle, a tram, a ride service vehicle, a shared vehicle, a taxi, an on-demand vehicle, a plane, and/or another public transport entity. In one or more embodiments, a public transportation timetable data structure can be configured with public transport timetable data associated with a schedule for arrival times and/or departure times related to a particular public transport at a particular location (e.g., a public transportation event location). For example, the public transport timetable data can include train schedule data associated with one or more scheduled departures and/or one or more scheduled arrivals of a train, bus schedule data associated with one or more scheduled departures and/or one or more scheduled arrivals of a bus, ride service vehicle data associated with one or more historical departures and/or one or more historical arrivals for a ride service vehicle, and/or other public transport schedule data.

Alternatively, the respective timetable data structures can include at least one event venue timetable data structure for at least one event venue associated with an event venue location deemed to be at least proximate to the location data. For example, the event venue timetable data structure can be related to a timetable for a sporting event, a timetable for a concert venue event, a timetable for a theatre venue event, a timetable for a cinema venue event, and/or another event venue entity. In one or more embodiments, an event venue timetable data structure can be configured with event venue timetable data associated with a schedule for beginning times and/or ending times related to a particular event venue at a particular location (e.g., an event venue location). For example, the event venue timetable data can include sporting event schedule data associated with a beginning time and/or an ending time for a sporting event, concert event schedule data associated with a beginning time and/or an ending time for a concert event, theatre event schedule data associated with a beginning time and/or an ending time for a theatre event, cinema event schedule data associated with a beginning time and/or an ending time for a cinema event, and/or other event venue schedule data.

In one or more embodiments, the apparatus 102, such as the processing circuitry 106, can be configured to compare frequency distribution peaks associated with the frequency distribution data structure to timetable times associated with the respective timetable data structure to refine the location data. For example, the apparatus 102, such as the processing circuitry 106, can be configured to determine whether a particular frequency distribution peak associated with the frequency distribution data structure matches a particular time (e.g., a departure time, an arrival time, a beginning time, or an ending time) for a public transportation event or event venue. In response to a determination that the particular frequency distribution peak associated with the frequency distribution data structure matches a particular timetable time associated with a timetable data structure, the apparatus 102, such as the processing circuitry 106, can be configured to refine the location data for the communication node based on a location associated with the public transportation event or event venue. Additionally or alternatively, the apparatus 102, such as the processing circuitry 106, can be configured to predict that the mobile device (e.g., mobile device 303) is at a location associated with the public transportation event or event venue. However, in response to a determination that the particular frequency distribution peak associated with the frequency distribution data structure does not match a particular timetable time associated with a timetable data structure, the apparatus 102, such as the processing circuitry 106, can be configured to determine that the communication node and/or the mobile device is not located at a location associated with the public transportation event or event venue.

Additionally or alternatively, the apparatus 102, such as the processing circuitry 106, can be configured to compare the one or more characteristics between the frequency distribution data structure and the respective timetable data structures based on a probability model applied to data within the frequency distribution data structure and the respective timetable data structures. For example, the probability model can be associated with a Gaussian mixture probability distribution such that the apparatus 102, such as the processing circuitry 106, can be configured to fit the Gaussian mixture probability distribution to the frequency distribution data structure (e.g., the histogram data structure) using one or more probability techniques associated with the probability model. In certain embodiments, the probability model can be configured as an Expectation-Maximization probability model associated with one or more Expectation-Maximization probability techniques.

In addition to generating the refined location data, the apparatus 102, such as the processing circuitry 106, can be configured to configure at least a portion of a radio model for the communication node based on the refined location data for the communication node. The radio model can model the communication node and/or related magnetic fields for future positioning purposes for mobile devices based on digital fingerprints. For example, the radio model can model coverage areas, communication node positions, radio propagation, receiver fields, and/or other radio communication modeling associated with the communication node. In one or more embodiments, the radio model can correspond to a portion of a radio map for the communication environment. For example, a collection of radio models including the radio model can form a radio map for the communication environment.

Referring back to FIG. 5, the apparatus 102, such as the processing circuitry 106, can compare one or more characteristics between the frequency distribution data structure 400 and respective timetable times of the one or more timetable data structures 502. The respective timetable times of the one or more timetable data structures 502 can be time data for respective scheduled events associated with a respective location. In various embodiments, the apparatus 102, such as the processing circuitry 106, can be configured to select the one or more timetable data structures 502 from a plurality of timetable data structures stored in a database or memory based on the location data included in the digital fingerprint 305. For example, the apparatus 102, such as the processing circuitry 106, can be configured to select one or more timetable data structures that are determined to be within a certain area (e.g., within 1 mile) with respect to the location data included in the digital fingerprint 305. In certain embodiments, the apparatus 102, such as the processing circuitry 106, can be configured to select one or more timetable data structures based on a size of a respective event associated with the one or more timetable data structures. For example, the apparatus 102, such as the processing circuitry 106, can be configured to select a timetable data structure in response to a determination that a size of a respective event for the timetable data structure is below a degree of uncertainty for the location data included in the digital fingerprint 305.

The apparatus 102, such as the processing circuitry 106, can also be configured to compare timetables times for each timetable data structure from the one or more timetable data structures 502 to histogram peak times and/or one or more other characteristics of the frequency distribution data structure 400 to determine whether the communication node 301 is likely located at least proximate a location associated with a public transportation event or an event venue related to the timetable data structure. For example, the apparatus 102, such as the processing circuitry 106, can also be configured to determine that the frequency distribution data structure 400 matches a timetable data structure from the one or more timetable data structures 502 in response to a determination that a certain amount of histogram peaks (e.g., 90% of the histogram peaks) of the frequency distribution data structure 400 matches a corresponding timetable time for the timetable data structure and/or is within one bin width for a timetable time for the timetable data structure. A histogram peak can be identified based on histogram peak criteria such as, for example, a value of a bin as compared to an average bin value for bins of the frequency distribution data structure 400, a bin value threshold for a bin of the frequency distribution data structure 400, an average number of histogram peaks within a certain interval of time, metadata in the digital fingerprint 305 that indicates that the mobile device 303 is at an event, and/or other histogram peak criteria.

In certain embodiments, the apparatus 102, such as the processing circuitry 106, can employ one or more cross-correlation matching techniques to compare characteristics of the frequency distribution data structure 400 to timetables times related to the one or more timetable data structures 502. For example, the apparatus 102, such as the processing circuitry 106, can be configured to perform a cross-correlation function between a first time series data structure representing the frequency distribution data structure 400 and a second time series data structure representing activities (e.g., an artificial time series representation of activities) related to the timetable times for the one or more timetable data structures 502. As such, in response to a determination that a cross correlation value between the first time series data structure and the second time series data structure is greater than a threshold cross correlation value, the apparatus 102, such as the processing circuitry 106, can be configured to determine that the frequency distribution data structure 400 matches the respective timetable data structure.

In certain embodiments, the apparatus 102, such as the processing circuitry 106, can apply one or more time shifts to one or more timetable times related to the one or more timetable data structures 502 based on the location data included in the digital fingerprint 305 and/or a type of event associated with a timetable data structure. For example, the apparatus 102, such as the processing circuitry 106, can apply a time shift to one or more timetable times related to a timetable data structure in response to a determination that the communication node 301 is located at a 2-minute walking distance from a public transportation event associated with the timetable data structure. The time shift can correspond to the 2-minute associated with the walking distance or another time shift weighted based on the walking distance time. In another embodiment, the apparatus 102, such as the processing circuitry 106, can apply one or more randomly generated time shifts to one or more timetable times related to the one or more timetable data structures 502 to account for potential minimal discrepancies between characteristics of the frequency distribution data structure 400 and timetable times related to the one or more timetable data structures 502.

In certain embodiments, the apparatus 102, such as the processing circuitry 106, can apply a time shift to one or more timetable times related to a timetable data structure based on user profile data associated with the mobile device 303. For example, the user profile data can include user preferences, user characteristics (e.g., an average walking stride length for a user associated with the mobile device 303, an average walking speed for a user associated with the mobile device 303), fitness activity data for a user associated with the mobile device 303, and/or other data associated with a user of the mobile device 303 to facilitate predicting a transit distance time to a location of an event associated with the timetable data structure, where the transit distance time can be employed to determine an amount of time shift for one or more timetable times related to a timetable data structure.

In certain embodiments, the apparatus 102, such as the processing circuitry 106, can additionally or alternatively apply a time shift to one or more timetable times related to a timetable data structure based on environmental data associated with the location included in the digital fingerprint 305. For example, the environmental data can include one or more road conditions (e.g., real-time road condition data, historical road condition data, a vehicle traffic condition, a road construction condition, etc.), pedestrian traffic conditions, weather conditions, and/or other environmental conditions that may be employed to determine an amount of time shift for one or more timetable times related to a timetable data structure.

In certain embodiments, the apparatus 102, such as the processing circuitry 106, can additionally or alternatively apply a time shift to one or more timetable times related to a timetable data structure based on a machine learning model. In one or more embodiments, the machine learning model can include model data and/or a prediction algorithm associated with transit distance time predictions for a location associated with a timetable data structure. In an embodiment, the machine learning model can be a decision tree model associated with a tree-like decision structure to facilitate obtaining transit distance time predictions. In another embodiment, the machine learning model can be a random forest model associated with one or more random decision forest structures to facilitate obtaining transit distance time predictions. In yet another embodiment, the machine learning model can be a neural network model (e.g., a deep learning model, an artificial neural network model, a convolutional neural network model, etc.) associated with artificial neural structures, convolutional layers, pooling layers, fully connected layers, connections, and/or weights to facilitate obtaining transit distance time predictions.

Based on a determination that the one or more characteristics of the frequency distribution data structure 400 matches one or more timetable times of the one or more timetable data structures 502, the apparatus 102, such as the processing circuitry 106, can be configured to generate refined location data 504 for the location data included in the digital fingerprint 305. For example, the refined location data 504 can be a refined location for the communication node 301. Additionally, the apparatus 102, such as the processing circuitry 106, can be configured to update a radio model 506 based on the refined location data 504. The radio model 506 can be a radio model for the communication node 301. Furthermore, the radio model 506 can correspond to a portion of a radio map for a communication environment associated with the communication node 301.

In certain embodiments, the apparatus 102, such as the processing circuitry 106, can store the frequency distribution data structure 400 for future use in response to a determination that the frequency distribution data structure 400 matches a timetable data structure from the one or more timetable data structures 502. Furthermore, in certain embodiments, the apparatus 102, such as the processing circuitry 106, can additionally or alternatively store the frequency distribution data structure 400 for future use in response to a determination that a location of the communication node 301 is unknown and/or a determination that a degree of difference between a coarse estimate of the location of the communication node 301 and a location associated with a timetable data structure is above or below a threshold value.

In various embodiments, the radio model 506 can be stored by one or more network entities such as, for example, the radio map data service system 308. For example, the radio model 506 can be stored in the radio map database 310. Additionally, in certain embodiments, the radio model 506 can be transferred to one or more of the mobile devices to facilitate determining a location and/or position of the one or more mobile devices. For example, while a mobile device is at an unknown location, the mobile device may capture one or more measurements of cellular or non-cellular signals transmitted by the communication node 301. Additionally, by employing the radio model 506 associated with the communication node 301, a location and/or position of the mobile device can be predicted.

In certain embodiments, the apparatus 102, such as the processing circuitry 106, can be configured to encode the refined location data 504 and/or the radio model 506 in a database (e.g., the radio map database 310) to facilitate location and/or position prediction for mobile devices. In certain embodiments, the apparatus 102, such as the processing circuitry 106, can be configured to map the refined location data 504 onto a map data layer. For example, in certain embodiments, the refined location data 504 can be employed for location and/or position predictions associated with real-time mapping and/or navigation for mobile devices. In certain embodiments, the apparatus 102, such as the processing circuitry 106, can be configured to provide an optimal end-to-end experience for a user via a user interface of a mobile device, where the refined location data 504 provides a reduction of queries and/or a reduction in a number of displays associated with user interaction with respect to the user interface. As such, in certain embodiments, the apparatus 102 can support a mapping, navigation, location and/or transit applications so as to present maps or otherwise provide navigation or user assistance, such as in an example embodiment in which map data is created or updated using methods described herein. For example, in certain embodiments, the apparatus 102, such as the processing circuitry 106, can be configured to create a grid of points where each point can correspond to predicted location for a communication node.

In certain embodiments, the apparatus 102, such as the processing circuitry 106, can be configured to provide for display of a map and/or instructions for following a navigation route via a user interface (e.g., a graphical user interface). In order to support a mapping application, the apparatus 102 can include or otherwise be in communication with a location database, such as the radio map database 310, a location database stored in the memory 108, and/or another map database related to the radio map data service system 308. For example, the location database can include node data records, communication node locations, point of interest (POI) data records, real-line geometries, pedestrian access points, pedestrian entrance points, pedestrian exit points, public transit information, road transit information, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or global positioning system (GPS) data associations (such as using known or future map matching or geo-coding techniques), for example. Furthermore, other positioning technology can be used, such as electronic horizon sensors, radar, LiDAR, ultrasonic sensors and/or infrared sensors.

In example embodiments, a navigation system user interface can be provided to provide navigation assistance to a user traveling along a navigation route. Establishing improved locations and positions along a navigation route for a user can provide information useful to navigation, pedestrian routing, and/or urban mobility such that map features in the map, e.g., a high definition (HD) map, associated with the specific locations can be reliably used to aid in navigation, pedestrian routing, and/or urban mobility.

Referring back to FIG. 3, the radio map data service system 308 that manages such map data can be in communication with one or more mobile devices via the network 312. The network 312 can be any form of wireless or partially wireless network as will be described further below. Additional, different, or fewer components can be provided. In an embodiment, the radio map data service system 308 can be a cloud service. For instance, in certain embodiments, the radio map data service system 308 can provide cloud-based services and/or can operate via a hosting server that receives, processes, and provides data to other elements of the system 300.

In certain embodiments, the radio map database 310 that can include communication node data records, transit segment or link data records, POI data records, real-line geometries, pedestrian access points, pedestrian entrance points, pedestrian exit points, transit platform information, and other data records. The radio map database 310 can also include routing data, in certain embodiments. According to some example embodiments, the road segment data records can be links or segments representing walkways, roads, streets, stairways, crosswalks, bridges, tunnels, elevators, escalators, or paths, as can be used in calculating a route or recorded route information for determination of one or more personalized routes. The node data can be end points corresponding to the respective links or segments of road segment data and/or transit data. The road link data and the node data can represent a transportation network, such as used by pedestrians, bicycles, scooters, vehicles, cars, trucks, buses, motorcycles, taxis, trains, subways, trams, planes and/or other entities. Optionally, the radio map database 310 can contain path segment and node data records or other data that can represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as transit stations, transit stops, transit connections, ride sharing connections, on-demand vehicle connections, fueling stations, hotels, restaurants, museums, stadiums, offices, auto repair shops, buildings, stores, parks, etc. The radio map database 310 can include data about the POIs and their respective locations in the POI records. The radio map database 310 can include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the radio map database 310 can include event data (e.g., traffic incidents, construction activities, scheduled events, unscheduled events, public transport events, venue events, etc.) associated with the POI data records or other records of the radio map database 310.

The radio map database 310 can be maintained by the radio map data service system 308 and can be accessed, for example, by the apparatus 102 of the radio map data service system 308. By way of example, the radio map data service system 308 can collect location data, geographic data and/or dynamic data to generate and enhance the radio map database 310. In one example, the dynamic data can include traffic-related data. In certain embodiments, remote sensing, such as aerial or satellite photography and/or LiDAR, can be used to generate at least a portion of map geometries directly or through machine learning.

In certain embodiments, map data can be compiled (e.g., such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to pedestrian navigation, vehicle navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases. In certain embodiments, the radio map database 310 can be used with a mobile device to provide a user with location, positioning, and/or navigation services. In such a case, one or more radio maps and/or other maps stored in the radio map database 310 can be downloaded or stored on a mobile device which can access the radio map database 310 through a wireless or wired connection, such as via the network 312, for example.

In certain embodiments, the apparatus 102, such as the processing circuitry 106, can be configured to map the refined location data 504 onto one or more map data layers of a map (e.g., a radio map, etc.) to facilitate navigation and/or routing associated with a user. For instance, in certain embodiments, the apparatus 102, such as the processing circuitry 106, can be configured to store the time to departure probability prediction in a map data layer of a map (e.g., a radio map, etc.) for positioning purposes, location purposes, mapping purposes, navigation purposes, and/or routing purposes. In certain embodiments, the apparatus 102, such as the processing circuitry 106, can be configured to link and/or associate the refined location data 504 with one or more portions, components, areas, layers, features, text, symbols, and/or data records of a map (e.g., a radio map, etc.). In one or more embodiments, the apparatus 102, such as the processing circuitry 106, can be configured to generate a data point for a map layer based on the refined location data 504. The data point can indicate a particular location for a communication node. Additionally or alternatively, in one or more embodiments, the apparatus 102, such as the processing circuitry 106, can be configured to store the data point in the radio map database 310 associated with a map layer.

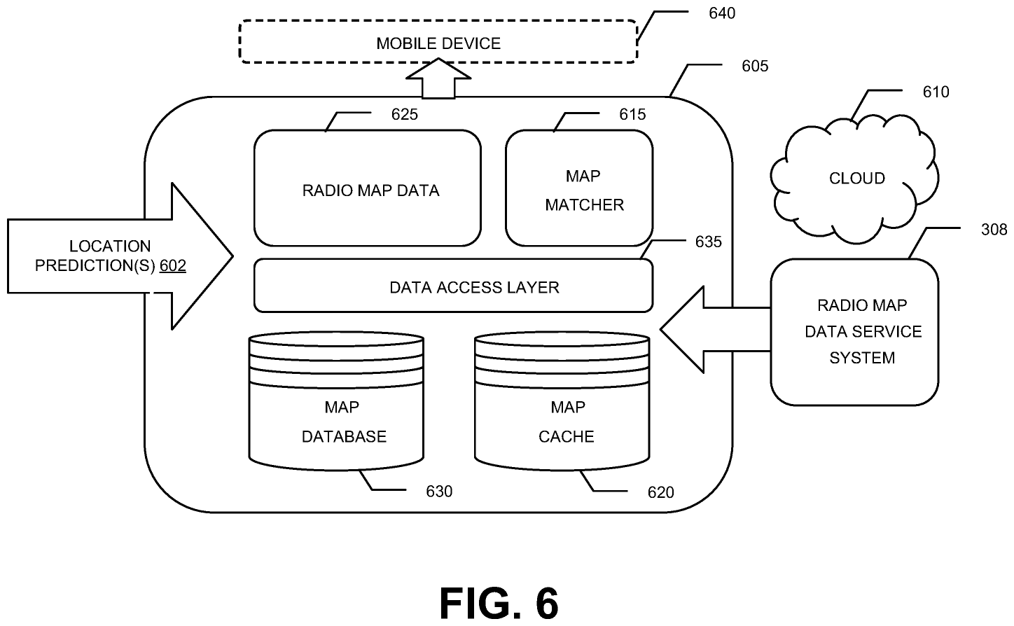

FIG. 6 illustrates an example embodiment of an architecture specifically configured for implementing embodiments described herein. The illustrated embodiment of FIG. 6 may be employed for position predictions, location predictions, navigation, routing and/or journey planning, where location prediction(s) 602 are determined for one or more communication nodes and/or one or more mobile devices. According to one or more embodiments, the location prediction(s) 602 can be correlated to radio map data of the radio map data service system 308. In certain embodiments, the location prediction(s) 602 can be correlated to one or more map data layers of a radio map. A mobile device may therefore acquire more accurate positioning information, location information, navigation information, routing information, transit information, and/or urban mobility information via the location prediction(s) 602. Additionally, the location prediction(s) 602 may provide a reduction in a number of queries and/or a number of displays via a user interface (e.g., a user interface of a mobile device) to facilitate navigation, routing, journey planning, and/or rendering of visual data via the user interface.

As illustrated in FIG. 6, the architecture includes the radio map data service system 308 that provides map data 625 (e.g., one or more radio maps, one or more radio models) to a mobile device 640. In one or more embodiments, the mobile device 640 can correspond to the mobile device 303. The radio map data service system 308 may be a cloud-based 610 service. In one or more embodiments, a server 605 receives the location prediction(s) 602 and may provide the location prediction(s) 602 to a map matcher 615. The map matcher 615 may correlate the location prediction(s) 602 to a link, segment and/or a probe point on a radio map stored in a map cache 620. In certain embodiments, the link, segment and/or probe point may be used to establish which map policies (e.g., radio map policies,) are applicable for providing positioning information, location information, navigation information, routing information, transit information, and/or urban mobility information to the mobile device 640. In certain embodiments, a data access layer 635 can manage and/or facilitate access to the map cache 620, the radio map data 625, and/or a map database 630. In an embodiment, at least a portion of the map database 630 can correspond to the radio map database 310.

By employing comparisons between frequency distribution data structures and timetable data structures to predict locations of communication nodes and/or mobile devices in accordance with one or more example embodiments of the present disclosure, precision and/or confidence of navigation, routing, and/or journey planning provided by a location service can be improved. Furthermore, by employing comparisons between frequency distribution data structures and timetable data structures to predict locations of communication nodes and/or mobile devices in accordance with one or more example embodiments of the present disclosure, optimized user interaction with respect to a user interface for navigation, routing, and/or journey planning can be provided. Moreover, in accordance with one or more example embodiments of the present disclosure, efficiency of an apparatus including the processing circuitry can be improved and/or the number of computing resources employed by processing circuitry can be reduced. In one or more embodiments, by employing comparisons between frequency distribution data structures and timetable data structures to predict locations of communication nodes and/or mobile devices in accordance with one or more example embodiments of the present disclosure, improved insights and/or recommendations related to rendered data for a user interface based on location can be provided.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed:

1. An apparatus configured for communication node localization, the apparatus comprising processing circuitry and at least one memory including computer program code instructions, the computer program code instructions configured to, when executed by the processing circuitry, cause the apparatus to:
receive a digital fingerprint associated with a communication node in a communication environment, wherein the digital fingerprint comprises at least location data associated with a location estimate of the communication node and timestamp data associated with one or more measurements with respect to the communication node;
configure a frequency distribution data structure for the communication node based at least in part on the timestamp data associated with the digital fingerprint; and
refine the location data to generate refined location data for the communication node based on a comparison of one or more characteristics between the frequency distribution data structure and respective timetable data structures for respective scheduled events associated with an event location deemed to be at least proximate to the location data.

2. The apparatus according to claim 1, wherein the computer program code instructions are configured to, when executed by the processing circuitry, cause the apparatus to:
modify a portion of the frequency distribution data structure that corresponds to a time value associated with the timestamp data.

3. The apparatus according to claim 1, wherein the frequency distribution data structure is configured as a histogram data structure associated with a histogram representing a frequency distribution of at least the timestamp data.

4. The apparatus according to claim 3, wherein the computer program code instructions are configured to, when executed by the processing circuitry, cause the apparatus to:
alter a data bin width associated with a defined interval of time for the histogram data structure based on the timestamp data associated with the digital fingerprint.

5. The apparatus according to claim 3, wherein the computer program code instructions are configured to, when executed by the processing circuitry, cause the apparatus to:
alter a histogram length for the histogram data structure based on the timestamp data associated with the digital fingerprint.

6. The apparatus according to claim 1, wherein the computer program code instructions are configured to, when executed by the processing circuitry, cause the apparatus to:
compare frequency distribution peaks associated with the frequency distribution data structure to timetable times associated with the respective timetable data structure to refine the location data.

7. The apparatus according to claim 1, wherein the computer program code instructions are configured to, when executed by the processing circuitry, cause the apparatus to:
compare the one or more characteristics between the frequency distribution data structure and the respective timetable data structures based on a probability model applied to data within the frequency distribution data structure and the respective timetable data structures.

8. The apparatus according to claim 1, wherein the computer program code instructions are configured to, when executed by the processing circuitry, cause the apparatus to:
configure at least a portion of a radio model for the communication node based on the refined location data for the communication node.

9. The apparatus according to claim 1, wherein the computer program code instructions are configured to, when executed by the processing circuitry, cause the apparatus to:
receive the digital fingerprint from a mobile device located within the communication environment.

10. The apparatus according to claim 1, wherein the respective timetable data structures comprise at least one public transportation timetable data structure for at least one public transportation event associated with a public transportation event location deemed to be at least proximate to the location data.

11. The apparatus according to claim 1, wherein the respective timetable data structures comprise at least one event venue timetable data structure for at least one event venue associated with an event venue location deemed to be at least proximate to the location data.

12. A computer-implemented method for communication node localization, the computer-implemented method comprising:
receiving a digital fingerprint associated with a communication node in a communication environment, wherein the digital fingerprint comprises at least location data associated with a location estimate of the communication node and timestamp data associated with one or more measurements with respect to the communication node;
configuring a frequency distribution data structure for the communication node based at least in part on the timestamp data associated with the digital fingerprint; and
refining the location data to generate refined location data for the communication node based on a comparison of one or more characteristics between the frequency distribution data structure and respective timetable data structures for respective scheduled events associated with an event location deemed to be at least proximate to the location data.

13. The computer-implemented method of claim 12, wherein configuring the frequency distribution data structure comprises modifying a portion of the frequency distribution data structure that corresponds to a time value associated with the timestamp data.

14. The computer-implemented method of claim 12, wherein configuring the frequency distribution data structure comprises configuring a histogram data structure associated with a histogram representing a frequency distribution of at least the timestamp data.

15. The computer-implemented method of claim 14, wherein configuring the histogram data structure comprises altering a data bin width associated with a defined interval of time for the histogram data structure based on the timestamp data associated with the digital fingerprint.

16. The computer-implemented method of claim 14, wherein configuring the histogram data structure comprises altering a histogram length for the histogram data structure based on the timestamp data associated with the digital fingerprint.

17. The computer-implemented method of claim 12, wherein refining the location data comprises comparing frequency distribution peaks associated with the frequency distribution data structure to timetable times associated with the respective timetable data structure to refine the location data.

18. The computer-implemented method of claim 12, wherein refining the location data comprises comparing the one or more characteristics between the frequency distribution data structure and the respective timetable data structures based on a probability model applied to data within the frequency distribution data structure and the respective timetable data structures.

19. The computer-implemented method of claim 12, further comprising:
configuring at least a portion of a radio model for the communication node based on the refined location data for the communication node.

20. A computer program product comprising at least one non-transitory computer-readable storage medium having computer-executable program code instructions stored therein, the computer-executable program code instructions comprising program code instructions to:
receive a digital fingerprint associated with a communication node in a communication environment, wherein the digital fingerprint comprises at least location data associated with a location estimate of the communication node and timestamp data associated with one or more measurements with respect to the communication node;
configure a frequency distribution data structure for the communication node based at least in part on the timestamp data associated with the digital fingerprint; and
refine the location data to generate refined location data for the communication node based on a comparison of one or more characteristics between the frequency distribution data structure and respective timetable data structures for respective scheduled events associated with an event location deemed to be at least proximate to the location data.
